(19) United States
(12) Patent Application Publication
(10) Pub. No.: US 2025/0347315 A1
(43) Pub. Date: Nov. 13, 2025

(54) BALL JOINT ASSEMBLY

(71) Applicant: AKTIEBOLAGET SKF, GOTEBORG (SE)

(72) Inventors: Salil Ganesh GAVANKAR, Schweinfurt (DE); Jan-Philip FISCHER, Schwebheim (DE); Johannes Andreas Rainer DEEG, Schweinfurt (DE); Juergen EYRICH, Burkardroth (DE)

(21) Appl. No.: 19/199,573

(22) Filed: May 6, 2025

(30) Foreign Application Priority Data
May 13, 2024 (DE) 102024204410.5

(51) Int. Cl. F16C 11/06

(52) U.S. Cl. CPC F16C 11/0671; F16C 11/0685

(57) ABSTRACT

A ball joint assembly includes a ball joint having a ball stud with a shaft portion and a ball head portion, the ball head portion being rotatably retained within a housing. The ball joint assembly further includes a dust cover adapted to cover the ball joint. The dust cover includes an upper-end portion and a lower-end portion. The upper-end portion is fixed to the housing and the lower-end portion is fixed to the shaft portion. Further, the dust cover is securely attached to the ball joint using at least one garter spring. The at least one garter spring is adapted to be arranged at the upper-end portion or at the lower-end portion and is configured to fasten the dust cover to the housing or to the shaft portion.

### CROSS-REFERENCE

This application claims priority to German patent application no. 102024204410.5 filed on May 13, 2024, the contents of which are fully incorporated herein by reference.

### BACKGROUND OF THE INVENTION

The present invention relates to joints, and more particularly to ball joints used in the automative industry.

Ball joints are essential components within automotive suspension and steering systems, facilitating multi-directional movements, and effectively transmitting mechanical loads between components. Despite their critical role, these joints are frequently subjected to harsh environmental conditions such as dirt, debris, moisture, and road contaminants, all of which can significantly degrade their performance and reliability over time. To safeguard against such damage, dust covers or “boots” are commonly employed as protective barriers for ball joints.

Traditionally, retaining clips such as flat spring/wire clips have been the primary means of securing the dust covers onto the ball joints. These clips apply a suitable radial force to ensure the proper positioning and function of the dust cover. However, during the assembly process the retaining clip needs to be expanded so that it can be assembled over the dust cover. For this purpose, a sharp clip expanding tool may be used that applies pressure on the retaining clip to expand the clip, which poses significant challenges. For example, the sharp edges of such tools have a propensity to damage the functional surface of the dust cover, leading to premature wear and tear and potential early failure during regular use.

In order to avoid, for example, premature wear due to damaged surfaces, such damage should be detected in good time. However, detecting damaged dust covers during the assembly process at the production level is challenging and often results in bypassed quality control measures. Moreover, the manual process of using sharp clip expanding tools is prone to a relatively high occurrence of process failure. This is because the process heavily depends on human operators, who may overlook damage caused during the assembly process. Such oversight may lead to additional costs and production delays. Additionally, when dust covers require replacement or servicing, the retaining clips must be stretched from their seating position, causing permanent deformation of standard retaining clips.

### SUMMARY OF THE INVENTION

It is therefore object of the present invention to provide a ball joint assembly comprising an improved attachment of the dust cover on the ball joint avoiding damages to the surface of the dust cover during the assembly process.

This object is solved by a ball joint assembly comprising a ball joint having a ball stud with a shaft portion and a ball head portion, wherein the ball head portion is rotatably retained within a housing. The housing may have a cap-like structure with a bottom opening and an internal cavity filled with lubricant. The internal cavity is configured to rotatably retain the ball head portion.

The ball joint assembly further comprises a dust cover adapted to cover the ball joint. The dust cover comprises an upper-end portion and a lower-end portion, wherein the upper-end portion is fixed to the housing, and the lower-end portion is fixed to the shaft portion of the ball joint. For example, the dust cover may be engaged with a recess provided on the outer peripheral surface of the bottom of the housing. Preferably, the dust cover may have a rim-like structure protruding from the upper-end portion, wherein the rim-like structure is configured to be fixed in the recess of the housing to cover the ball joint.

To attach the dust cover on the ball joint without damaging the surface of the dust cover, the ball joint assembly comprises at least one garter spring arranged at the upper-end portion and/or at the lower-end portion of the dust cover. The at least one garter spring is configured to fasten the dust cover to the housing and/or to the shaft portion of the ball joint, respectively. The proposed garter spring offers a unique solution for securely attaching the dust cover to the ball joint, even under significant stress or force. Its flexibility allows easy expansion over the dust cover without causing any damage, and its demounting process requires less extraction force than traditional retaining clips. Thus, using a garter spring to attach the dust cover to the ball joint provides a secure attachment, as with previously used retaining clips, while at the same time avoiding damage to the surface of the dust cover.

The dust cover may be provided with an annular groove at the upper-end portion and/or the lower-end portion for accommodating the at least one garter spring. This enables the at least one garter spring to be securely and firmly attached to the dust cover, providing a more reliable and stable attachment of the dust cover to the ball joint.

Further, the at least one garter spring may be in the form of a closed ring, or any other expandable form, which can be easily expanded and slid onto the dust cover. Alternatively, the at least one garter spring may have two free ends adapted to be connected to each other. Thus, the at least one garter spring may be easily mounted around the dust cover due to its open form and may then be closed or connected to form a closed ring around the dust cover. Moreover, the length of the garter spring may be adjusted by cutting its free ends before connecting the ends. This means that the length of the garter spring may be adjusted to the proper size of the dust cover. This adjustment may increase the clamping or compression force of the garter spring around the dust cover to hold it securely in place. For connecting the two open ends, a first end of the two free ends may be inserted into a second end of the two free ends. The first end may be formed by reducing the cross-section diameter towards the end of the wire coil. The first end may then be easily inserted into the second end, which forms a kind of screwing of the first end into the second end.

When designing the garter spring to hold the dust cover in place, different characteristics of the garter spring may be optimized, in particular dimensions of the garter spring like the diameter of the coil wire, the diameter of the cross section of the spring, and/or the length of the wire in its free state. These dimensions or characteristics of the garter spring may be particularly optimized to improve the flexibility and the clamping force of the garter spring to effectively retain the dust cover on the housing and/or the shaft portion of the ball joint.

Thus, according to an embodiment, the at least one garter spring has a cross-section diameter De that is equal to or less than the inner diameter of the annular groove at the upper-end portion and/or the inner diameter of the annular groove at the lower-end portion. The cross-section diameter may be selected to be similar to the cross-section diameter of the currently used retaining clips. This ensures that the at least one garter spring could be easily integrated into existing designs, by selecting a cross-section diameter similar to the currently used retaining clips.

For example, for a specific application, the at least one garter spring may have a cross-section diameter De that is equal to or less than 1.8 millimeters, i.e., De≤1.8 mm. This cross-section diameter allows the garter spring to fit within the limited space available on the dust cover. For example, the dust cover may have a diameter between 16 millimeters to 33 millimeters with a thickness between 3.5 millimeters and 5.4 millimeters, and the cross-section diameter De of ≤1.8 mm may be optimized to be fitted within these dimensions of the dust cover. Such a cross-section diameter may also ensure that the garter spring maintains the necessary flexibility to expand over the dust cover to be demounted from the dust cover without premature deformation.

In addition, the garter spring with a cross-section diameter De of ≤1.8 mm may have the same dimensions as the previously used retaining clips and may thus be suitable for assembling on existing dust covers, eliminating the need to design a new dust cover. This makes the proposed garter spring a suitable replacement for the traditional retaining clip, offering compatibility with various applications.

Further, the at least one garter spring may have a wire diameter d between 0.1 millimeters and 0.7 millimeters, preferably between 0.1 millimeters and 0.5 millimeters. This wire diameter d may be optimized to enhance the radial force exerted by the garter spring, in particular for providing sufficient force to hold the dust cover on the ball joint.

According to a further embodiment, the at least one garter spring provides a radial force rf that is configured to fasten the dust cover to the housing and/or to the shaft portion. This radial force rf exerted by the garter spring is directed radially from the axis around which the dust cover rotates or moves. This is essential for securing the dust cover on the ball joint, even during the multi-directional movement of the ball joint. For instance, the at least one garter spring may be optimized to provide a radial force rf with a magnitude of between 45 newtons and 85 newtons, preferably between 60 newtons and 70 newtons, to fasten the dust cover to the housing and/or to the shaft portion. This radial force value may be optimized to be greater than or equal to the radial force value provided by a traditional retaining clip.

Additionally, other dimensions of the garter spring may be optimized, such as the number of coils, length of the garter spring, spring rate, and inner diameter based on the dimensions of the dust cover. For example, the inner diameter Di of the garter spring may be optimized to be equal to the outer diameter of the upper and/or lower-end portion to ensure proper fit and provide enough compression or clamping force on the upper and/or lower-end portion of the dust cover. Thus, by optimizing the dimensions and characteristics of the garter spring to the specific use case, garter springs with different sizes and dimensions may be provided that are suitable for assembly on several existing dust covers.

The dust cover of the ball joint assembly may have an upper-end portion with a larger annular diameter than the lower-end portion. Specifically, the inner diameter of the upper-end portion may be configured to be equal to the housing's outer diameter, while the inner diameter of the lower-end portion may be equal to the shaft's outer diameter. This configuration facilitates an easy engagement of the upper-end portion with the recess of the housing and of the lower-end portion with the shaft portion of the ball joint.

According to an embodiment, the ball joint assembly comprises a first garter spring and a second garter spring, wherein the first garter spring is arranged at the upper-end portion of the dust cover to fasten the dust cover to the housing and a second garter spring is arranged at the lower-end portion of the dust cover to fasten the dust cover to the shaft portion. These first and second garter springs may be optimized to be accommodated within the upper-end portion and the lower-end portion, in particular within a respective annular groove, ensuring a secure fastening of the dust cover.

According to a further embodiment, the first garter spring is different from the second garter spring in wire diameter and/or in radial force. Preferably, the first garter spring may be larger with respect to the wire diameter than the second garter spring. For instance, the wire diameter of the first garter spring may be between 0.38 millimeters and 0.42 millimeters and the wire diameter of the second garter spring may be between 0.32 millimeters and 0.37 millimeters. This is because the first garter spring may be configured to hold the upper-end portion of the dust cover, which has a larger outer diameter than the lower-end portion of the dust cover, onto the housing and simultaneously fix the housing to the ball head portion. On the other hand, the second garter spring may be configured to fix the lower-end portion of the dust cover directly onto the shaft portion. In the case of this embodiment, the first garter spring requires a greater load capacity, strength and radial force to effectively hold the heavier load at the upper-end portion (caused by the housing in combination with the dust cover) compared to the second garter spring. Hence, as the wire diameter influences the load capacity, strength and radial force provided, the wire diameter of the first garter spring may be optimized to be greater than that of the second garter spring.

According to a further preferred embodiment, the first garter spring provides a greater radial force than the second garter spring. As described above, the upper-end portion of the dust cover may experience a heavier load than the lower-end portion. Thus, the first garter spring requires a higher radial force, for instance, between 65 newtons and 70 newtons, to fasten the upper-end portion with a larger outer diameter, for example about 33 millimeters, and a higher radial thickness, for example about 5.4 millimeters, onto the housing than the second garter spring, which requires for instance a radial force between 60 newtons and 64 newtons to hold the lower-end portion with a comparatively lesser outer diameter, for example about 16 millimeters, and a lesser radial thickness, for example about 3.5 millimeters, onto the shaft portion.

Alternatively, when the upper-end portion of the dust cover has the same or similar dimensions as the lower-end portion of the dust cover, the first garter spring may be similar to the second garter spring. Thus, the dimensions of the first and second garter springs may be optimized based on the dimensions of the dust cover to snugly fit and/or exert a radial force on the upper-end portion and the lower-end portion to hold the dust cover on the housing and the shaft portion, respectively.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE SEVERAL VIEWS OF THE DRAWINGS

In the following, preferred embodiments of the invention are described in relation to the drawings, wherein the drawings are exemplary only, and are not intended to limit the scope of protection. The scope of protection is defined by the accompanied claims, only. The figures show:

FIG. 1 is a schematic cross-section of a ball joint assembly;

FIG. 2 is a perspective schematic view of the ball joint assembly of FIG. 1;

FIG. 3 a schematic illustration of a garter spring to be used in the ball joint assembly of FIGS. 1 and 2; and

FIG. 4 a cross-section of the perspective view of FIG. 2.

### DETAILED DESCRIPTION OF THE INVENTION

In the following same or similar functioning elements are indicated with the same reference numerals.

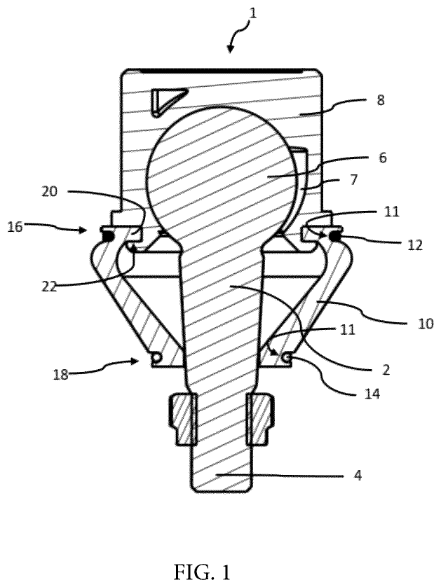

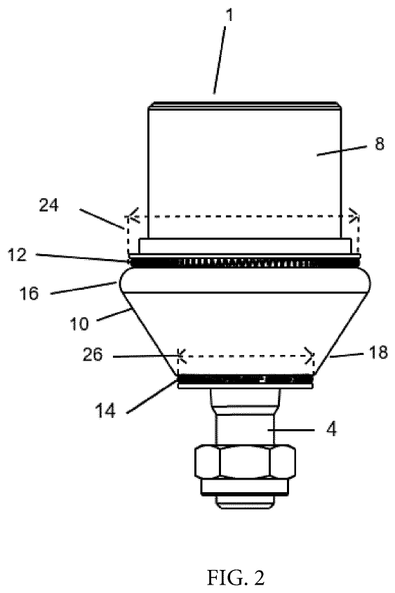

FIGS. 1 and 2 show a ball joint assembly 1, which comprises a ball joint having a ball stud 2 with a shaft portion 4 and a ball head portion 6. The ball head portion 6 is rotatably retained within a housing 8 that is filled with lubricant 7. The ball joint assembly 1 further comprises a dust cover 10 which is adapted to cover the ball joint and to protect it from harsh environmental conditions such as dirt, debris, moisture, or road contaminants.

The dust cover 10 includes an upper-end portion 16 and a lower-end portion 18. The upper-end portion 16 is configured to be fixed on the housing 8 and the lower-end portion 18 is configured to be fixed on the shaft portion 4. The dust cover 10 further comprises a rim-like structure 20 protruding from the upper-end portion 16. As shown in the drawing figures, the rim-like structure 20 may be configured to engage with a recess 22 formed on the housing 8.

Until now, a retaining clip was used to retain the dust cover on the ball joint. However, during the assembly process, the retaining clip needed to be expanded over the dust cover using an assembly tool, which can damage the surface of the dust cover due to sharp edges of the tool. Such damage is likely to occur even before the dust cover is fixed onto the ball joint, causing an early failure during regular use, or while demounting the dust cover for replacement. Further, during demounting, the previously used retaining clips must be stretched from their seating position, causing deformation of the retaining clips.

Thus, instead of using such a retaining clip, the ball joint assembly 1 of the present invention includes at least one garter spring 12 and/or 14 for keeping the dust cover 10 securely attached to the ball joint. As shown in FIGS. 1 and 2, the ball joint assembly 1 may include two garter springs 12, 14 which are respectively arranged on the upper-end portion 16 and the lower-end portion 18 to fasten the dust cover 10 onto the housing 8 and/or onto the shaft portion 4, respectively. Alternatively, the ball joint assembly 1 may comprise only one garter spring 12 or 14 or may comprise more than two garter springs.

Each garter spring 12, 14 is flexible, and thus requires less force to expand the garter springs 12, 14, allowing for easy expansion over the dust cover 10 without damaging the surface of the cover 10 and further preventing deformation of the garter spring 12, 14 during the demounting process. During replacement of the dust cover 10 or removing the dust cover 10 for servicing of the ball joint, the garter springs 12 14 must be stretched from their seating position to demount them from the dust cover 10. Unlike the retaining clips that tend to deform when stretched out from their seated position, the garter springs 12, 14 can expand easily and return to their original shape due to their inherent flexibility.

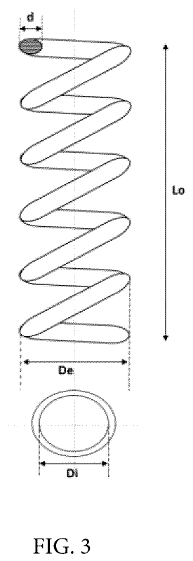

Each garter spring 12, 14 may have a closed ring form. Alternatively, the garter springs 12, 14 may each be in an open form before assembly. In the latter case, when in an unassembled and uncompressed state, the garter springs 12, 14 are each in an extended form with two free ends (not indicated), as shown in FIG. 3. The two free ends can be connected to each other, forming a closed ring around the dust cover 10, as depicted in FIG. 2. Further, the length of each garter spring 12, 14 may be adjusted by cutting at least one of the free ends before connecting the ends, allowing the springs 12, 14 to be sized to the dust cover 10. Thus, the size of the garter springs 12, 14 can be easily manipulated by adjusting their length in order to apply the necessary compression force around the dust cover 10 required to hold the cover 10 securely in place.

Further, the dimensions and characteristics of the garter springs 12, 14, such as cross-section diameter, wire diameter, length, inner diameter, and/or radial force, can be optimized to hold the dust cover 10 onto the ball joint. When optimized, the garter springs 12, 14 can provide the same functionality as the previously used retaining clips. For example, by making the cross-section diameter of the garter springs 12, 14 equal to or less than 1.8 millimeters, which may be optimized to be similar to the cross-section diameter of the previously utilized retaining clips, the garter springs 12, 14 can hold the dust cover 10 in place in a manner similar to the previously used retaining clips.

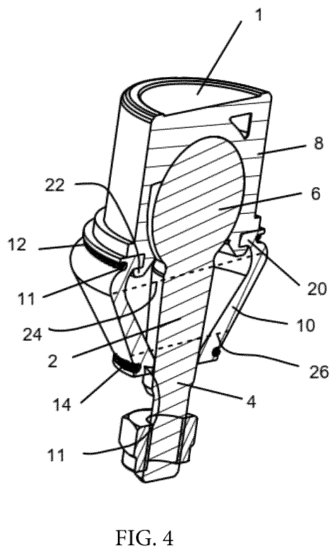

As shown in FIGS. 2 and 4, the dust cover 10 is preferably provided with an annular groove 11 at both the upper-end portion 16 and the lower-end portion 18 in order to accommodate the garter springs 12, 14. Specifically, the first garter spring 12 is accommodated in the annular groove 11 of the upper-end portion 16 of the dust cover 10 and the second garter spring 14 is accommodated in the annular groove 11 of the lower-end portion 18 of the dust cover 10. Thus, the first garter spring 12 fastens the upper-end portion 16 to the housing 8 and the second garter spring 14 fastens the lower-end portion 18 to the shaft portion 4.

Further, the upper-end portion 16 of the dust cover 10 has an outer diameter 24 with a greater value than an outer diameter 26 of the lower-end portion 18 of the dust cover 10, as shown in FIG. 2. Thus, in order to fit and hold the upper-end portion 16 and lower-end portion 18, the wire diameter d of the first garter spring 12 is optimized to be preferably greater than the wire diameter d of the second garter spring 14. As such, the first garter spring 12 is thicker than the second garter spring 14 in order to provide a greater compression force and thus allowing the first spring 12 to easily hold the upper-end portion 16 of the dust cover 10, which has a greater outer diameter 24 than the lower end portion 18, onto the housing 8.

Preferably, to provide the radial force required to clamp and hold the upper-end portion 16 and lower-end portion 18 onto the housing 8 and shaft portion 4, respectively, the dimensions of the garter springs 12, 14, such as the wire diameter, number of coils, and cross-section diameter, can be optimized. The first garter spring 12 may need to exert a greater radial force to clamp and hold the upper-end portion 12 (as the upper-end portion 12 represents a heavier load caused by the larger outer diameter of the upper-end portion 12) and to simultaneously fix it to the housing 8. The wire diameter influences the stiffness of the garter springs 12, 14, which, in turn, influences the magnitude of the radial force exerted by the garter springs 12, 14. Thus, increasing the wire diameter of the first garter spring 12 increases the magnitude of the radial force of the first garter spring 12, which is suitable to hold the upper-end portion 16 onto the housing 8.

For instance, in the case of an upper-end portion 16 of the dust cover 10 having an outer diameter about 33 millimeters and a lower-end portion 18 of the dust cover 10 having an outer diameter about 16 millimeters, the wire diameter d of the first garter spring 12 may be optimized to be between 0.38 millimeters and 0.42 millimeters to provide a radial force with a magnitude of between 65 newtons and 70 newtons. The wire diameter d of the second garter spring 14 may be optimized to be between 0.32 millimeters and 0.37 millimeters to provide a radial force with magnitude of between 60 newtons and 64 newtons, respectively. Thus, by optimizing the dimensions of each garter spring 12, 14 based on the dimensions of the dust cover 10, the two garter springs 12, 14 can be configured to hold the dust cover 10 in place by snugly fitting and exerting the necessary radial force for compression or clamping.

In summary, an improved attachment of the dust cover 10 to the housing 8 is provided by using one or more garter springs 12, 14 to attach the dust cover 10 securely to the ball joint without damaging the surface of the cover 10. Each garter spring 12, 14 has a flexibility and provides a radial force of an appropriate magnitude, which allows the springs 12, 14 to readily expand over and demount from the dust cover 10 without causing any damage to the dust cover's surface while also compressing or clamping the dust cover 10 in place.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### REFERENCE NUMERALS

1 ball joint assembly
2 ball stud
4 shaft portion
6 ball head
7 housing filled with lubricant
8 housing
10 dust cover
12 first garter spring
14 second garter spring
16 upper-end portion
18 lower-end portion
20 rim-like structure
22 recess
24 outer diameter of the upper-end portion
26 outer diameter of the lower-end portion
d wire diameter of the garter spring
De cross-section diameter of the garter spring
Lo length of the garter spring
Di inner diameter of the garter spring

We claim:

1. A ball joint assembly comprising:
a ball joint including a ball stud with a shaft portion and a ball head portion;
a housing, the ball head portion being rotatably retained within the housing;
a dust cover adapted to cover the ball joint and including an upper-end portion fixed to the housing and a lower-end portion fixed to the shaft portion of the ball stud; and
at least one garter spring arranged at the upper-end portion of the dust cover and configured to fasten the dust cover to the housing and/or at the lower-end portion of the dust cover and configured to fasten the dust cover to the shaft portion.

2. The ball joint assembly according to claim 1, wherein the dust cover is provided with an annular groove at the upper-end portion and/or at the lower-end portion for accommodating the at least one garter spring.

3. The ball joint assembly according to claim 2, wherein the at least one garter spring has a cross-section diameter less than or equal to an inner diameter of the annular groove at the upper end portion or less than or equal to an inner diameter of the annular groove at the lower end portion.

4. The ball joint assembly according to claim 1, wherein the at least one garter spring provides a radial force of sufficient magnitude to fasten the dust cover to the housing or to the shaft portion.

5. The ball joint assembly according to claim 1, wherein the at least one garter spring includes a first garter spring arranged at the upper-end portion of the dust cover to fasten the dust cover to the housing and a second garter spring arranged at the lower-end portion of the dust cover to fasten the dust cover to the shaft portion.

6. The ball joint assembly according to claim 5, wherein the first garter spring has a wire diameter different than a wire diameter of the second garter spring and/or the first garter spring provides a radial force different in magnitude than a radial force provided by the second garter spring.

7. The ball joint assembly according to claim 5, wherein the first garter spring has a wire diameter greater than a wire diameter of the second garter spring.

8. The ball joint assembly according to claim 5, wherein the first garter spring provides a radial force with a greater magnitude than a radial force provided by the second garter spring.

9. The ball joint assembly according to claim 1, wherein at least one garter spring has two free ends adapted to be connected to each other.

10. The ball joint assembly according to claim 1, wherein the housing has a recess and the dust cover has a rim-like structure protruding from the upper-end portion of the dust cover and configured to be fixed at the recess of the housing.
